(19) United States
(12) Patent Application Publication
(10) Pub. No.: US 2021/0207896 A1
(43) Pub. Date: Jul. 8, 2021

(54) CIRCULATION DUCT FOR CONVEYING A FLUID OF A HEAT EXCHANGER, AND HEAT EXCHANGER

(71) Applicant: Valeo Termico, S.A., Zaragoza (ES)

(72) Inventors: Yolanda Bravo Rodriguez, Zaragoza (ES); Juan Carlos De Francisco Moreno, Zaragoza (ES); Fernando Puertolas Sanchez, Zaragoza (ES); Maria Luisa Miedes Arnal, Zaragoza (ES)

(73) Assignee: Valeo Termico, S.A., Zaragoza (ES)

(21) Appl. No.: 15/999,642

(22) PCT Filed: Feb. 17, 2017
(86) PCT No.: PCT/EP2017/053628

§ 371 Date: Aug. 20, 2018

(30) Foreign Application Priority Data
Feb. 19, 2016 (ES) 201630189

(51) Int. Cl. F28D 21/00; F28D 7/16

(52) U.S. Cl. CPC F28D 21/0003; F28F 1/426; F28D 7/1684

(57) ABSTRACT

Circulation duct for conveying a fluid of a heat exchanger, and heat exchanger.

The duct (1) comprises two surfaces (s1, s2), each with a plurality of protruding elements (p) which project inside the duct (1), and are arranged adjacent to one another, forming a row which includes protruding elements (p) with a different form, and extends in a longitudinal direction according to the main direction of circulation Y of the fluid circulating, such that the flow of fluid encounters protruding elements (p) which are different sequentially both in space, according to this longitudinal direction, and in time, thus generating a plurality of disordered current lines (L).

The heat exchanger comprises circulation ducts for a fluid, at least one of which is formed according to the circulation duct of the present invention.

### FIELD OF THE INVENTION

The present invention relates in general, in a first aspect, to a circulation duct for conveying a fluid of a heat exchanger, provided with a plurality of protruding elements which generate turbulence, and more particularly to a circulation duct with an improved arrangement of protruding elements.

A second aspect of the present invention relates to a heat exchanger which comprises one or more circulation ducts formed according to the duct of the first aspect of the invention.

The invention applies especially to exhaust gas recirculation exchangers of an engine (Exhaust Gas Recirculation Coolers or EGRC).

### PRIOR ART

The main function of EGR exchangers is the exchange of heat between the exhaust gases and the coolant fluid, for the purpose of cooling the gases.

At present, EGR heat exchangers are widely used for diesel applications, for the purpose of reducing the emissions, and they are also used in petrol applications in order to reduce the consumption of fuel.

Basically, there are two types of EGR heat exchangers, i.e. a first type which consists of a casing inside which there is a bundle of parallel tubes which constitute circulation ducts for the passage of the gases, with the coolant circulating through the casing on the exterior of the pipes, and the second type consists of a series of parallel plates which constitute the heat exchanger surfaces, such that the exhaust gases and coolant circulate through circulation ducts defined between two respective plates, in alternating layers, and can include fins in order to improve the heat exchange.

The market trend is to reduce the size of engines, and to use EGR heat exchangers not only in high pressure (HP) applications, but also in low-pressure (LP) applications; both of these have an impact on the design of the EGR heat exchangers. Vehicle manufacturers are demanding EGR heat exchangers with higher performance, and at the same time the space available in order to position the exchanger and its components is increasingly small and more difficult to incorporate the exchanger.

In other words, the requirements for the design and production of EGR exchangers have developed, such that increasingly compact heat exchangers are required. There are two ways of increasing this compactness, i.e. the one which is based on providing the heat exchanger surface with secondary surfaces (fins), and the one which is based on including specific protrusions (or undulations) on the surfaces in order to promote the turbulence of the gas circulating, and therefore increase the value of the heat transfer coefficient.

The proposals which are based on defining protrusions have great potential for increasing the compactness of the final product in comparison with the other existing technologies, despite the fact that the inclusion of these protrusions also increases the loss of pressure of the gas circulating. On the other hand, in comparison with the proposals which are based on the inclusion of secondary surfaces (fins), the impact of this parameter (loss of pressure) would be lower if account is taken of the effect of the phenomenon known as fouling, in other words the accumulation of dirt, in general carbon. This is because the hydraulic diameter associated with the proposals based on promoting turbulence, in other words those based on protrusions, is larger than that associated with the proposals based on fins, such that the former prevent severe accumulation of carbon inside the exchange unit.

Patent documents exist which describe proposals based on protrusions, differentiated above all by the type of protrusions and the manner of arranging them inside the circulation ducts of the heat exchangers.

One of these proposals is described in patent ES 2259265 B1, by the same holder as the present application, in which a tube for conveying a fluid of a heat exchanger is described, comprising two walls which are opposite according to a direction Z, each of which is provided with at least one discontinuous corrugation situated facing a corresponding discontinuous corrugation arranged on the opposite wall, which walls are arranged such that the projection of these walls in the direction Z on a plane XY defines a silhouette substantially in the form of an “X”.

Another one of these proposals based on the inclusion of protrusions inside the circulation duct is described in patent ES 2496943 T3, corresponding to the validation of European patent EP 1682842 B1, which combines the characteristics defined in the preamble of Claim 1 of the present invention.

In the circulation duct proposed in ES 2496943 T3, the protruding elements in the row are in general the same as one another. However, in the description it is stated very generically that “it would be possible to use in a row different structural elements, e.g. 13 and 14”, although ES 2496943 T3 does not describe protruding elements which are very different from one another, since all of those described are based on one or more segments of straight and/or curved elongate elements.

However, the most important thing is that the row of protruding elements which are different from one another to which ES 2496943 T3 refers goes in a direction which is transverse to the main direction of circulation of the fluid circulating through the duct, such that each of the different protruding elements affects a different transverse portion of the fluid wave front, and only once during the circulation of the fluid through the circulation duct.

Thus, the results which are obtained in terms of thermal efficiency by means of the proposal made in ES 2496943 T3 can clearly be improved.

It therefore appears necessary to provide an alternative to the prior art which makes up for the gaps it contains, by providing a solution which substantially improves the performance provided by the circulation ducts with protruding elements according to the prior art.

### EXPLANATION OF THE INVENTION

For this purpose, a first aspect of the present invention relates to a circulation duct for conveying a fluid of a heat exchanger in a main direction of circulation Y, which comprises in a known manner two heat exchanger surfaces substantially opposite one another, wherein each surface comprises a plurality of protruding elements which project inside the circulation duct, and are arranged adjacent to one another, forming at least one row which includes protruding elements which are different.

Unlike the known circulation ducts, and in particular unlike the one described in ES 2496943 T3, in which the row of protruding elements which are different runs in a direction transverse to the main direction of circulation Y, in the circulation duct according to the first aspect of the present invention, the said row extends at least in a longitudinal direction according to the main direction of circulation Y, such that the flow of fluid encounters protruding elements which are different sequentially both in space, according to this longitudinal direction, and in time, thus generating a plurality of disordered current lines.

This results in far better performance in terms of thermal efficiency, since each portion of the circulating fluid wave front is affected by different protruding elements, at different moments and in different locations along the duct.

According to one embodiment, the said protruding elements have forms which are different from one another.

In another embodiment which is an alternative or complementary to the previous one, the protruding elements have orientations which are different from one another.

In another embodiment which is an alternative or complementary to the previous ones, the protruding elements have dimensions which are different from one another.

According to one embodiment, the said row also includes protruding elements with the same form and dimensions.

In another embodiment which is an alternative or complementary to the previous one, the row also includes protruding elements with the same form but different dimensions and/or different orientations.

According to another embodiment, the row comprises a series of protruding elements which follow a pattern of repetition or a sequence of two or more different protruding elements (in terms of the form and/or dimensions and/or orientation) which are repeated twice or more along the row.

According to one embodiment, the row extends along at least 70% of the length of the duct, such that the fluid which circulates through the duct interacts with the protruding elements along most of the duct.

According to one embodiment, the row includes two or more sub-rows of protruding elements which extend longitudinally in the main direction of circulation Y, with at least one of these sub-rows, in a variant of this embodiment, including protruding elements with different forms, different dimensions and/or a different orientation.

In a variant of this embodiment, at least one of the sub-rows includes protruding elements which invade spatially another one of the sub-rows, such that a portion of them is interposed between the protruding elements of this other sub-row.

In another embodiment, the row includes protruding elements which are arranged displaced transversely within the row, or one of these sub-rows, and are staggered in a direction transverse to the main direction of circulation Y.

Specifically, for different embodiments, the row includes protruding elements with two or more of the following forms, when seen in plan view, or a combination of these: circle, oval, rhombus, triangle, rectangle, and elongate elements which follow one or more straight and/or curved trajectories.

According to one embodiment, the said protruding elements with an elongate form which follow more than one trajectory are formed by segments with different angles of orientation.

According to one embodiment, the row includes protruding elements with a form which is a combination of two or more of the said forms, such as an elongate form with a central area in the form of a circle.

Preferably, the ends and/or vertices of the forms of the protruding elements are rounded.

According to another embodiment, the row includes protruding elements with a form which is a variation of one of the forms listed above, including a form similar to a triangle, a rhombus or a rectangle, but with one of its sides curved.

According to one embodiment, at least one of the protruding elements of one of the two opposite surfaces of the duct is superimposed by at least one protruding element of the other surface.

In a variant of this embodiment, the aforementioned superimposed protruding elements are different in terms of at least dimensions.

In another variant of this embodiment, the aforementioned superimposed protruding elements are different in terms of at least orientation.

In another variant of this embodiment, the aforementioned superimposed protruding elements are different in terms of at least form.

According to another variant of this embodiment, the aforementioned superimposed protruding elements have an elongate form, and are superimposed such that projection of one on another defines a form substantially in the form of an “X”.

According to an implementation of this variant, the said form of an “X” is not symmetrical.

According to one implementation, the smaller angle formed by the two segments of the “X” is between 26° and 40°.

According to another variant of the said embodiment, at least two protruding elements of one of the two opposite surfaces of the duct are superimposed on a protruding element of the other surface, such that a projection of these two protruding elements on the other defines a form substantially in the form of a double “X”.

The above variants of the embodiment relating to the at least two protruding elements superimposed on one another are independent or can be combined with one another, according to the implementation of the circulation duct of the first aspect of the present invention.

All of the variety of possible combinations of protruding elements covered by the above-described embodiments, which all have in common the fact that they include different protruding elements in the main direction of circulation Y, makes it possible to design the circulation duct in a manner which is personalized for each application, in order to obtain the required performance levels and adapt to the conditions of work and requirements specific to the application, for example in terms of compactness, thus optimizing the heat exchange and reducing as far as possible the loss of pressure of the fluid circulating.

The protruding elements have a maximum height in general of 1 to 2 mm, although other values are also possible.

Advantageously, the maximum height of each protruding element (i.e. the distance from the surface from which the elements project, in a direction orthogonal to this surface) is less than two fifths of the distance between the two heat exchanger surfaces which are opposite one another.

A second aspect of the present invention relates to a heat exchanger, in particular to cool exhaust gases of an engine, which comprises ducts for circulation of a fluid, wherein at least one of these circulation ducts is formed according to the duct of the first aspect of the invention.

According to one embodiment of the heat exchanger of the second aspect of the present invention, the circulation ducts are formed by tubes inside which these exhaust gases circulate, and around which a coolant fluid circulates for heat exchange with the exhaust gases, and at least the heat exchanger surfaces which comprise protruding elements do so as tube walls.

In a variant of this embodiment, the tube walls are flat, and in general the transverse cross sections of the tubes have a rectangular form.

As an alternative, in other variants of this embodiment, the transverse cross sections of the tubes are circular or have an oval form.

According to one embodiment, the length of each tube is between 80 mm and 220 mm.

In another embodiment, the circulation ducts are formed by stacking of plates or discs, wherein at least the heat exchanger surfaces which comprise protruding elements do so as opposite walls of at least two of the said plates or discs.

### BRIEF DESCRIPTION OF THE DRAWINGS

The above advantages and characteristics, as well as others, will be understood more fully from the following detailed description of some embodiments with reference to the appended drawings, which should be taken by way of non-limiting illustration, and in which:

FIGS. 1a, 1b, 1c and 1d illustrate an embodiment of the circulation duct proposed by the first aspect of the present invention, with FIG. 1c showing the duct in perspective, FIG. 1a showing a plan view from above of one of the surfaces of the duct, FIG. 1b showing a plan view from above of the opposite surface, and FIG. 1d being a projection on a plane XY which shows the superimposition of the protrusions of both surfaces;

FIGS. 2a, 2b, 2c and 2d illustrate, in a manner similar to FIG. 1, another embodiment of the circulation duct proposed by the first aspect of the present invention;

FIGS. 3a, 3b, 3c and 3d illustrate, in a manner similar to FIGS. 1 and 2, another embodiment of the circulation duct proposed by the first aspect of the present invention;

FIGS. 4a, 4b, 4c and 4d illustrate, in a manner similar to FIGS. 1, 2 and 3, another embodiment of the circulation duct proposed by the first aspect of the present invention;

FIGS. 5a, 5b and 5c are respectively plan views of the surfaces of the circulation duct proposed by the first aspect of the invention and a projection on a plane XY which shows the superimposition of the protrusions of both surfaces, for yet another embodiment;

FIG. 6 shows in perspective, for one embodiment, part of the duct proposed by the first aspect of the invention, together with a schematic representation obtained by means of mathematical simulation, of the disordered current lines generated by the flow of fluid circulating through the duct when it encounters the protruding elements along the duct;

FIG. 7 shows in perspective for the same embodiment as FIG. 6, part of the duct proposed by the first aspect of the invention, together with portions of some vectors representative of the flow of fluid circulating through the duct, on the basis of data obtained by means of mathematical simulation, wherein the portions of vectors are illustrated for three transverse regions spaced along the duct, and with different shades of grey corresponding to different orders of magnitude of the speed of the fluid, in m/s, according to the scale represented in the figure, and which values are also obtained by means of simulation;

FIG. 8 is a view similar to FIG. 7, for the same embodiment, which also illustrates the results of mathematical simulations, without portions of vectors being illustrated in this case, and representing the different speed values also by means of different shades of grey, however on three respective transverse planes spaced along the duct; and

FIG. 9 is a view similar to FIG. 8, for the same embodiment, however in this case the values represented by means of a scale of greys on the three respective transverse planes spaced along the duct do not correspond to speed values, but to orders of magnitude of vectorial vorticity, m/s, according to the scale represented in the figure.

### DETAILED DESCRIPTION OF SOME EMBODIMENTS

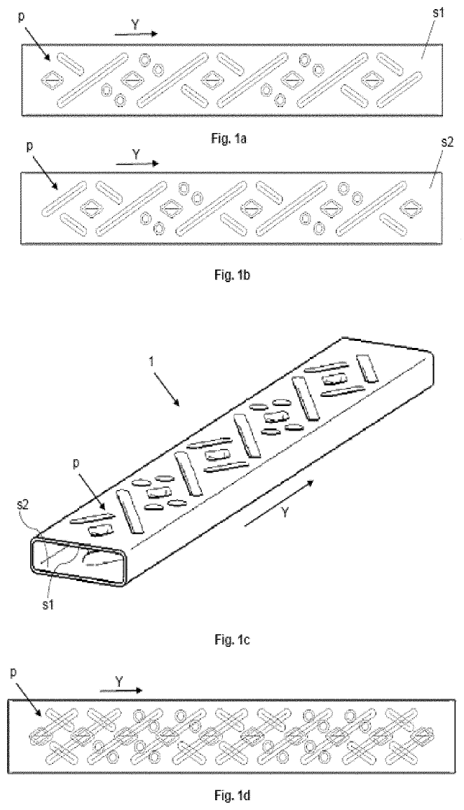

FIGS. 1 to 5 illustrate different embodiments of the circulation duct 1 proposed by the first aspect of the present invention, all of them having in common the fact that they relate to a circulation duct 1 for conveying a fluid of a heat exchanger in a main direction of circulation Y, which comprises two heat exchanger surfaces s1, s2 substantially opposite one another, wherein each of the surfaces s1, s2 comprises a plurality of protruding elements p which project inside the circulation duct 1, arranged adjacent to one another and forming at least one row which includes protruding elements p which are different in terms of their form and/or dimensions and/or orientation, and extend in a longitudinal direction according to the main direction of circulation Y.

In particular, in the embodiments illustrated by these FIGS. 1 to 5, the heat exchanger surfaces s1, s2 are the inner surfaces of flat main walls of a tube with a rectangular cross section which forms the circulation duct, although the same (or similar) distributions of protruding elements p illustrated can be applied to surfaces, whether flat or not, of another class of circulation ducts different from those illustrated.

The embodiments in FIGS. 1 to 5 are differentiated from one another by the different types with reference to the form and/or dimensions and/or orientation of protruding elements p included in them, as well as by the number and distribution of the elements along the row.

In particular, in the embodiment illustrated in FIGS. 1a, 1b, 1c and 1d, protruding elements are included with forms (in plan view) of a: rhombus, circle and elongate elements (similar to pegs) with different lengths and orientations which each follow a single straight trajectory. All of the forms illustrated have their ends and/or vertices rounded.

It can be seen from FIGS. 1a, 1b and 1d that the arrangement of protruding elements p not only follows a pattern according to a row in the direction Y, but that there are also sub-patterns grouped around some of the protruding elements according to different arrangements, in particular inclined groups of protruding elements p, the forms of which correspond to those of two pairs of circles with a rhombus in the middle arranged alternately (according to the row in the direction Y) with inclined groups of forms of two pairs of short pegs with a rhombus in the middle, separated by protruding elements p in the form of inclined long pegs.

As can be seen in FIG. 1d, as the protruding elements p project from the surface s1 onto those of the surface s2, silhouettes substantially in the form of an “X” are defined, both for each pair of elongate protruding elements (pegs), and for each inclined group of protruding elements.

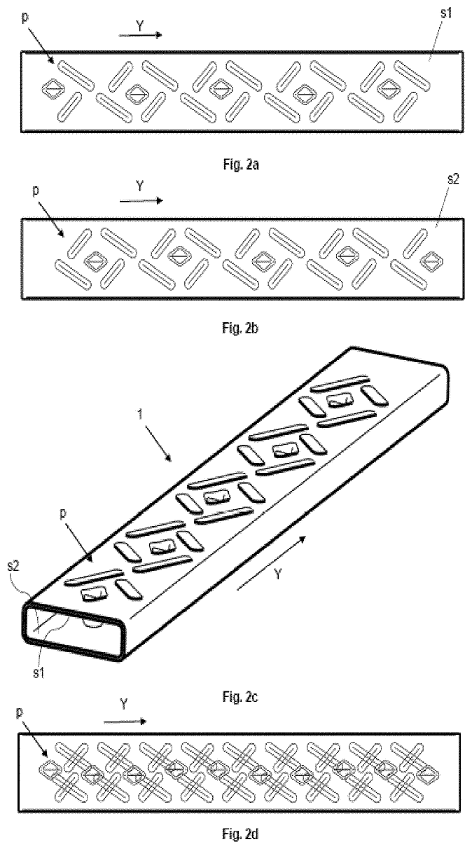

As can be seen from FIG. 1c, the protruding elements p in question are made of respective stampings formed from the outer faces of the larger flat walls of the tubular duct 1, so that in reality FIG. 1a (and also FIGS. 2a, 3a, 4a and 5a) show, indicated as p, the depressions caused by these stampings which form the protrusions in the inner face of the duct 1. Any other method of configuring and arranging these protruding elements in the surfaces s1, s2 other than stamping is also possible, and is covered by the present invention.

In the embodiment in FIGS. 2a, 2b, 2c and 2d, protruding elements are included with forms (in plan view) of a rhombus and elongate elements (similar to pegs) with different lengths which each follow a single straight trajectory. All the forms illustrated have their ends and/or vertices rounded.

In this embodiment, the row of protruding elements includes three sub-rows, i.e. a central row formed by the forms in the shape of a rhombus (where, unlike the embodiment in FIG. 1, these are slightly offset spatially alternately), an upper row formed by a sequence of pairs of pegs with a different length and orientation, and a lower row similar to the upper one, wherein both respective end portions of the protruding elements p of the upper sub-row and the lower sub-row invade the space between each of the two rhombuses of the central sub-row.

As shown in FIG. 2d, as the protruding elements p project from the surface s1 onto those of the surface s2, in this case also silhouettes substantially in the form of an “X” are defined for each pair of elongate protruding elements (pegs).

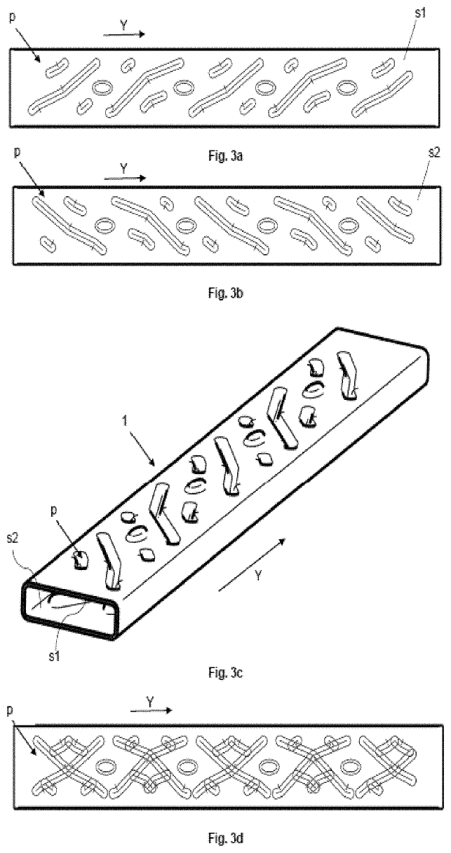

In the embodiment in FIGS. 3a, 3b, 3c and 3d, protruding elements are included with forms (in plan view) of an oval, and elongate elements (similar to pegs) with different lengths each formed by straight segments with different angles of orientation.

In this embodiment, as can be seen in FIG. 3d, as the protruding elements p project from the surface s1 onto those of the surface s2, there is also definition of silhouettes substantially in the form of an “X” for each pair of elongate protruding elements (pegs).

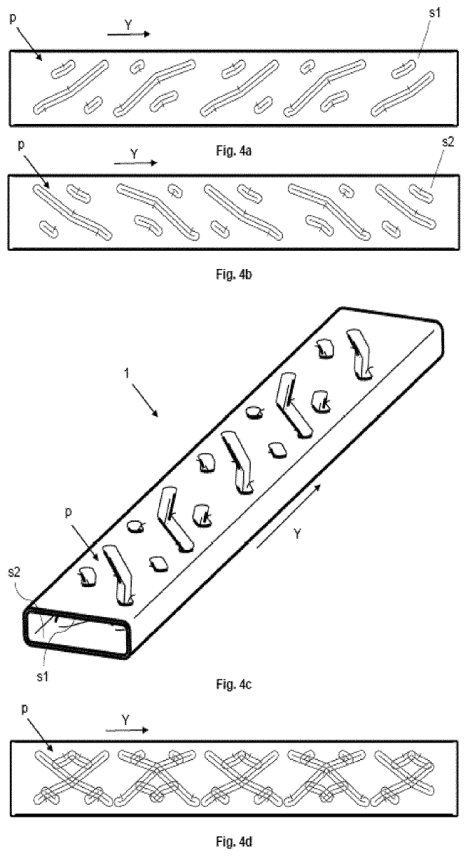

The embodiment in FIGS. 4a, 4b, 4c and 4d differs from the one in FIGS. 3a, 3b, 3c and 3d only in that it does not include the protruding elements with a form (in plan view) of an oval.

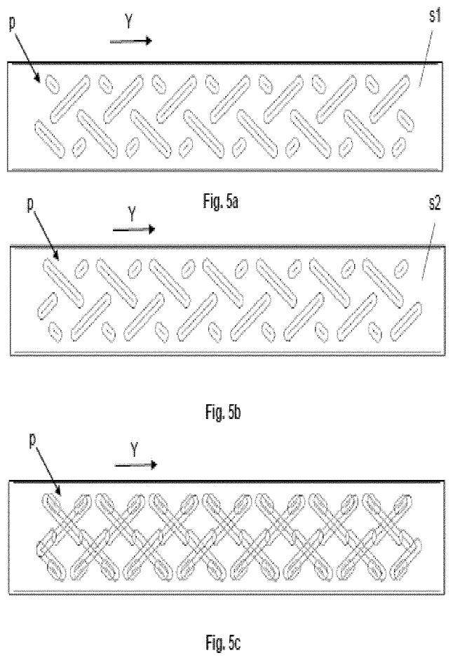

FIGS. 5a, 5b and 5c illustrate another embodiment of the circulation duct proposed by the first aspect of the invention, which includes protruding elements only with elongate forms (similar to pegs), but with different dimensions and different orientations, grouped according to different sub-rows, including protruding elements p which invade spatially another one of the sub-rows, in particular the lower ends of the protruding elements p of the upper sub-row (according to the position illustrated in FIG. 5a) are interposed between the upper ends of the protruding elements p of the lower sub-row, and vice versa.

In this case, as shown in FIG. 5c, as the protruding elements p of the surface s1 project onto those of the surface s2, there is also definition of silhouettes substantially in the form of an “X”, for each pair of elongate protruding elements with the same dimensions.

The present inventors have carried out a series of digital simulations for a circulation duct as illustrated in FIGS. 1a, 1b, 1c and 1d, and the results of these are illustrated in FIGS. 6 to 9 graphically on a portion of the circulation duct 1 (although the simulations were carried out for the complete duct).

The simulations were carried out for a circulation duct with a tubular form and a rectangular cross section, with dimensions substantially 100 mm long, 14.5 mm high and 4.35 mm wide, with a wall thickness of 0.4 mm, and for protruding elements with a maximum height of substantially 1.3 mm (measured from the inner face of the wall from which they extend).

In particular, FIG. 6 shows the disordered current lines generated by the flow of fluid circulating through the duct when it encounters the protruding elements p along the duct. The current lines illustrated are more tortuous, and there are a larger number of them than those generated in the circulation ducts according to the prior art, meaning that the fluid emerges from the duct at a temperature lower than that obtained with the ducts according to the prior art (for a duct with the same dimensions).

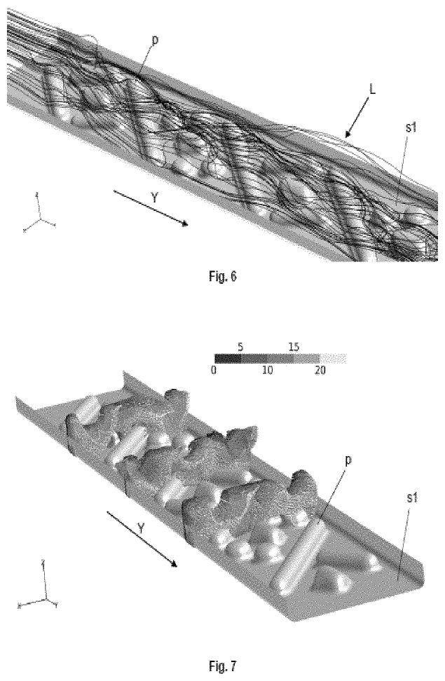

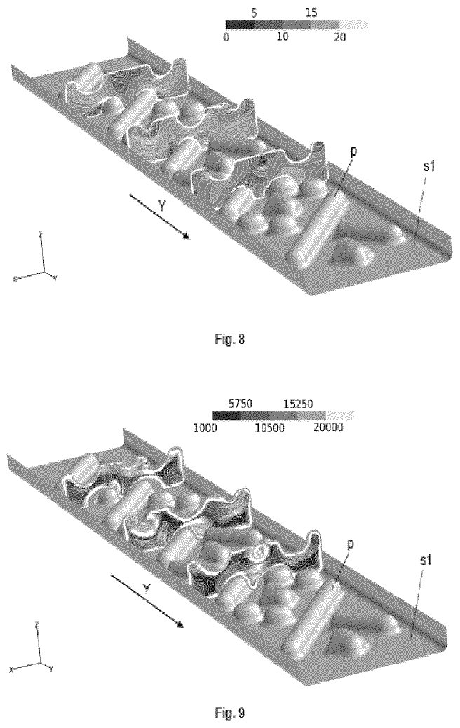

FIGS. 7 and 8 represent in a scale of greys the values of the speed (m/s) in terms of magnitude (modulus) of the fluid circulating through the circulation duct, for three transverse regions spaced along the duct, and FIG. 9 represents the vectorial vorticity values (/s) for the same three transverse regions.

The results obtained show the validity of the arrangement along the duct of protruding elements with different forms, which applies not only to the embodiment for which the digital simulation results have been represented graphically (FIGS. 6 to 9), but also to the remaining embodiments illustrated (FIGS. 2 to 5), and in general to any embodiment which includes different protruding elements along the circulation duct.

Persons skilled in the art could introduce changes and modifications to the embodiments described without departing from the scope of the invention as defined in the appended claims.

1. Circulation duct (1) for conveying a fluid of a heat exchanger in a main direction of circulation Y, which comprises two surfaces (s1, s2) of the heat exchanger substantially opposite one another, wherein each of the said surfaces (s1, s2) comprises a plurality of protruding elements which project inside the circulation duct (1), and are arranged adjacent to one another, forming at least one row which includes protruding elements (p) which are different, characterized in that the said row extends at least in a longitudinal direction according to the main direction of circulation Y, such that the flow of fluid encounters protruding elements (p) which are different sequentially both in space, according to this longitudinal direction, and in time, thus generating a plurality of disordered current lines (L).

2. Circulation duct according to claim 1, wherein the said protruding elements (p) have forms which are different from one another.

3. Circulation duct according to claim 1 or 2, wherein the said protruding elements (p) have orientations which are different from one another.

4. Circulation duct according to any one of the preceding claims, wherein the said protruding elements (p) have dimensions which are different from one another.

5. Circulation duct according to any one of the preceding claims, wherein the said row also includes protruding elements (p) with the same form and dimensions.

6. Circulation duct according to any one of the preceding claims, wherein the said row also includes protruding elements (p) with the same form but different dimensions and/or different orientations.

7. Circulation duct according to any one of the preceding claims, wherein the row comprises a series of protruding elements (p) which follow a pattern of repetition or a sequence of two or more different protruding elements (p) which are repeated twice or more along the row.

8. Circulation duct according to any one of the preceding claims, wherein the row includes at least two sub-rows of protruding elements (p) which extend longitudinally in the main direction of circulation Y.

9. Circulation duct according to claim 6, wherein at least one of these two or more sub-rows includes protruding elements (p) with different forms, different dimensions and/or a different orientation.

10. Circulation duct according to claim 8 or 9, wherein at least one of the sub-rows includes protruding elements (p) which invade spatially another one of the sub-rows, such that a portion of them is interposed between the protruding elements (p) of this other sub-row.

11. Circulation duct according to any one of the preceding claims, wherein the row includes protruding elements (p) which are arranged displaced transversely within the row, or one of these sub-rows, and are staggered in a direction transverse to the main direction of circulation Y.

12. Circulation duct according to any one of the preceding claims, wherein the row includes protruding elements (p) with at least two of the following forms, when seen in plan view, or a combination of these: circle, oval, rhombus, triangle, rectangle, and elongate elements which follow one or more straight and/or curved trajectories.

13. Circulation duct according to any one of the preceding claims, wherein the row includes protruding elements (p) with an elongate form which follow more than one straight and/or curved trajectory, and are formed by segments with different angles of orientation.

14. Circulation duct according to claim 12 or 13, wherein the row includes protruding elements (p) with a form which is a combination of two or more of the said forms.

15. Circulation duct according to any one of the preceding claims, wherein the ends and/or vertices of the forms of the protruding elements (p) are rounded.

16. Circulation duct according to any one of the preceding claims, wherein at least one of the protruding elements (p) of one (s1) of the said two surfaces (s1, s2) is superimposed by at least one protruding element (p) of the other surface (s2), the said superimposed protruding elements (p) being different in terms of at least dimensions.

17. Heat exchanger, in particular to cool exhaust gases of an engine, which comprises ducts for circulation of a fluid, characterized in that at least one circulation duct (1) is formed according to one of the preceding claims.

18. Heat exchanger according to claim 17, wherein the circulation ducts are formed by tubes inside which these exhaust gases circulate, and around which a coolant fluid circulates for heat exchange with the exhaust gases, and wherein at least the heat exchanger surfaces (s1, s2) which comprise protruding elements (p) do so as tube walls.

19. Heat exchanger according to claim 18, wherein the said tube walls are flat.

20. Heat exchanger according to claim 17, wherein the circulation ducts are formed by stacking of plates or discs, wherein at least the heat exchanger surfaces (s1, s2) which comprise protruding elements (p) do so as opposite walls of at least two of the said plates or discs.
